(19) United States
(12) Patent Application Publication
(10) Pub. No.: US 2011/0155873 A1
(43) Pub. Date: Jun. 30, 2011

(54) MOUNTING SYSTEM FOR RELEASABLY SECURING AN ENTERTAINMENT MODULE TO AN AUTOMOTIVE HEADREST

(75) Inventors: Sean David Montag, Westerville, OH (US); Paul Eugene Hsu, Lewis Center, OH (US); Michael Thomas Kopczewski, Grove City, OH (US)

(73) Assignee: WINEGARD COMPANY, Burlington, IA (US)

(21) Appl. No.: 12/979,589

(22) Filed: Dec. 28, 2010

Related U.S. Application Data
(60) Provisional application No. 61/291,198, filed on Dec. 30, 2009.

(51) Int. Cl. B60R 11/02

(52) U.S. Cl. 248/218.4; 248/219.4

(57) ABSTRACT

A mounting system (1) for a rear-facing, entertainment module (3) such as a digital VHF/UHF television, 3G Internet device, or DVD/CD/game player. The mounting system (1) has first and second, principal sections (5,7) with the first section (5) being securable to the upright posts (8,8′) of an automotive headrest (4) and the second section (7) being mounted for pivotal movement relative to the first section (5). The portable entertainment module (3) in turn is then removably attachable to the second section (7) of the mounting system (1) for viewing by a rear-seat passenger. The first section (5) is securely clamped to the upright posts (8,8′) in a fixed position and the second section (7) with the entertainment module (3) attached can be pivoted as desired for best viewing by the passenger. In one embodiment, the first and second sections (5,7) are integral with each other. In a second embodiment, the first and second sections (5,7) are releasably securable to each other by a manually operable latching arrangement.

### RELATED APPLICATIONS

This application claims the benefit of U.S. Provisional Patent Application Ser. No. 61/291,198 filed Dec. 30, 2009, which is incorporated herein by reference.

### BACKGROUND OF THE INVENTION

1. Field of the Invention

This invention relates to the field of mounting systems for releasably securing a portable entertainment module to an automotive headrest.

2. Discussion of the Background

Portable entertainment modules such as digital VHF/UHF televisions, 3G Internet devices, and DVD/CD/game players are very popular for use in automobiles and other vehicles to entertain the rear-seat passengers. In a typical setting, the portable module is releasably secured to a mounting system that is attached to the upright posts of the automotive headrest. The mounting system commonly has a first section securable to the headrest posts in a fixed position and a second section that can be adjusted (e.g., pivoted) relative to the first section. The entertainment module in turn is then removably secured to the second section of the mounting system. Many such arrangements exist but each has drawbacks as to the ease of mounting and operation and its ability to fit headrest posts in a variety of vehicles in which the posts are spaced at different distances apart.

In this light, the mounting system of the present invention was developed. The mounting system in particular can be easily and quickly attached to a variety of automotive headrest configurations. Additionally, the mounting system enables the portable entertainment module to be conveniently and quickly attached to it for viewing and removed for storage or use at another location or docking station.

### SUMMARY OF THE INVENTION

This invention involves a mounting system for a rear-facing, entertainment module such as a digital VHF/UHF television, 3G Internet device, or DVD/CD/game player. The mounting system has first and second, principal sections with the first section being securable to the upright posts of an automotive headrest and the second section being mounted for pivotal movement relative to the first section. The portable entertainment module in turn is then removably attachable to the second section of the mounting system for viewing by a rear-seat passenger. The first section is securely clamped to the upright posts of the headrest in a fixed position and the second section with the entertainment module attached can be pivoted as desired for best viewing by the passenger.

The first section of the mounting system has a base plate member with T-shaped notches and adjustable clamping arrangements. In use the T-shaped notches and clamping arrangements enable the first section to be mounted to a variety of headrest configurations in which the uprights posts are spaced different distances from each other. The second section and module then have an interactive latching arrangement that allows the user to easily and quickly attach and remove the module from the mounting system as well as adjust the module for best viewing.

In one embodiment, the first and second sections of the mounting system are integral with each other. In a second embodiment, the first and second sections are releasably securable to each other by a manually operable latching arrangement. The second section in this regard then has a first latching arrangement for removably securing it to the first section of the mounting system and a second latching arrangement for removably attaching it to the entertainment module.

### BRIEF DESCRIPTION OF THE DRAWINGS

FIG. 1 is a perspective view of the mounting system of the present invention in use to support a rear-facing, entertainment module on the upright posts of an automotive headrest.

FIG. 2 is an opposite perspective view from FIG. 1 with the padded section of the automotive headrest of FIG. 1 removed for clarity.

FIGS. 3a and 3b are perspective views of the present invention with the entertainment module removed from the mounting system

FIG. 4 is a perspective view similar to FIG. 1 but with the entertainment module removed to show the mounting system as secured to the upright posts of the automotive headrest.

FIG. 5 is a view similar to FIG. 4 showing the mounting system alone.

FIGS. 6a and 6b are further views of the mounting system.

FIG. 7a is an exploded view of part of the first section of the mounting system, which first section is securable to the upright posts of the automotive headrest.

FIG. 7b illustrates the base member of the first section of the mounting system and the T-shaped notches in it to receive the upright posts of the automotive headrest.

FIG. 8a is a perspective view of components of the mounting system.

FIG. 8b shows a manual assembly step for positioning one of the clamp members of the mounting system in place relative to one of the upright posts of the automotive headrest.

FIG. 9 is a further perspective view of components of the mounting system.

FIGS. 10a-10h are views from all sides of the second section of the mounting system, which second section is securable to the removable entertainment module.

FIGS. 11a-11b are further views of the second section of the mounting system.

FIGS. 12-16 sequentially show how the entertainment module can be lowered onto the second section of the mounting system.

FIG. 17 is a perspective view of FIG. 16.

FIG. 18 is a perspective view of a second embodiment of the mounting system of the present invention in use to support a rear-facing, entertainment module on the upright posts of an automotive head rest.

FIG. 19 is an opposite perspective view from FIG. 18 with the padded section of the automotive headrest of FIG. 18 removed for clarity.

FIG. 20 is a view similar to FIG. 19 with the entertainment module shown in a position removed from the mounting system.

FIG. 21 is a perspective view similar to FIG. 18 but with the entertainment module removed to show the mounting system as secured to the upright posts of the automotive headrest.

FIG. 22 is a view similar to FIG. 21 showing the mounting system of the second embodiment alone.

FIG. 23 is a view of the first and second sections of the mounting system with the first section partially exploded.

FIG. 24 shows the first and second sections of the mounting system secured to each other

FIG. 25 shows the first and second sections of the mounting system separated from each other.

FIG. 26 is a plan cross-sectional view of the first and second sections secured to each other.

FIG. 27a is a plan cross-sectional view of the first and second sections separated from each other.

FIG. 27b shows the latch members of the latching arrangement of FIG. 27a in their retracted positions.

### DETAILED DESCRIPTION OF THE INVENTION

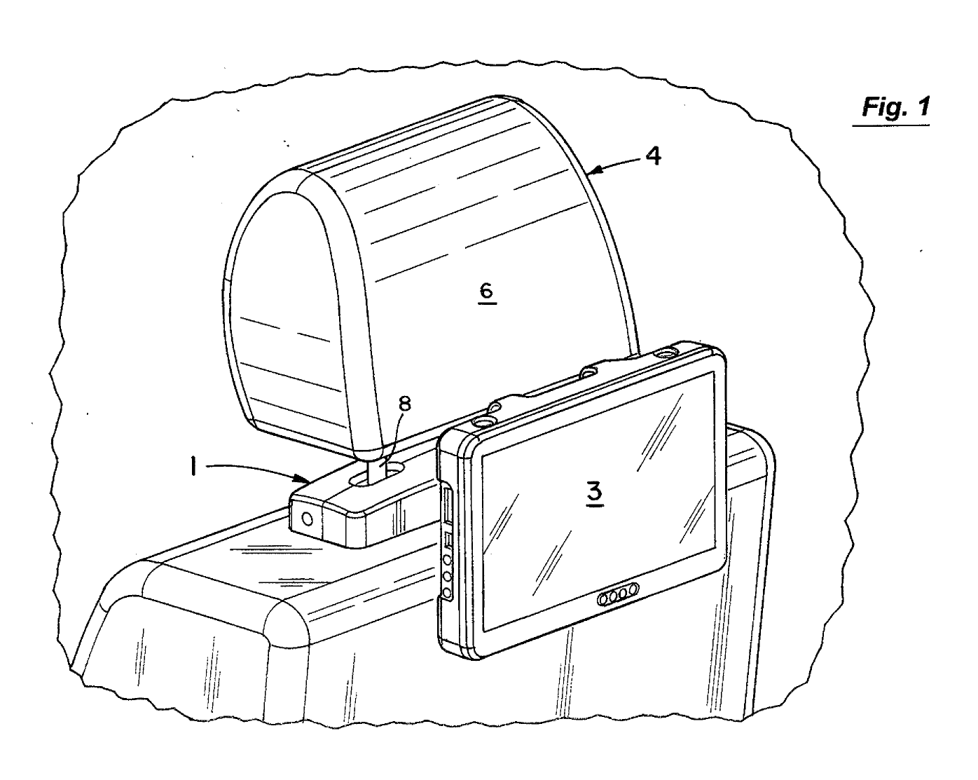

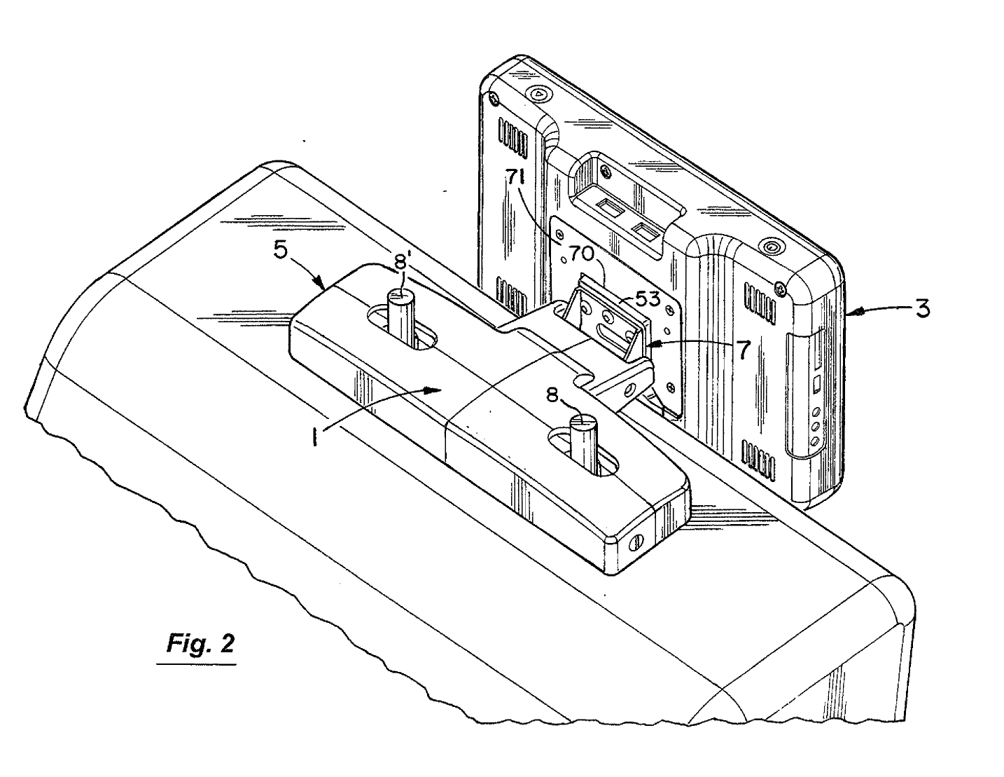

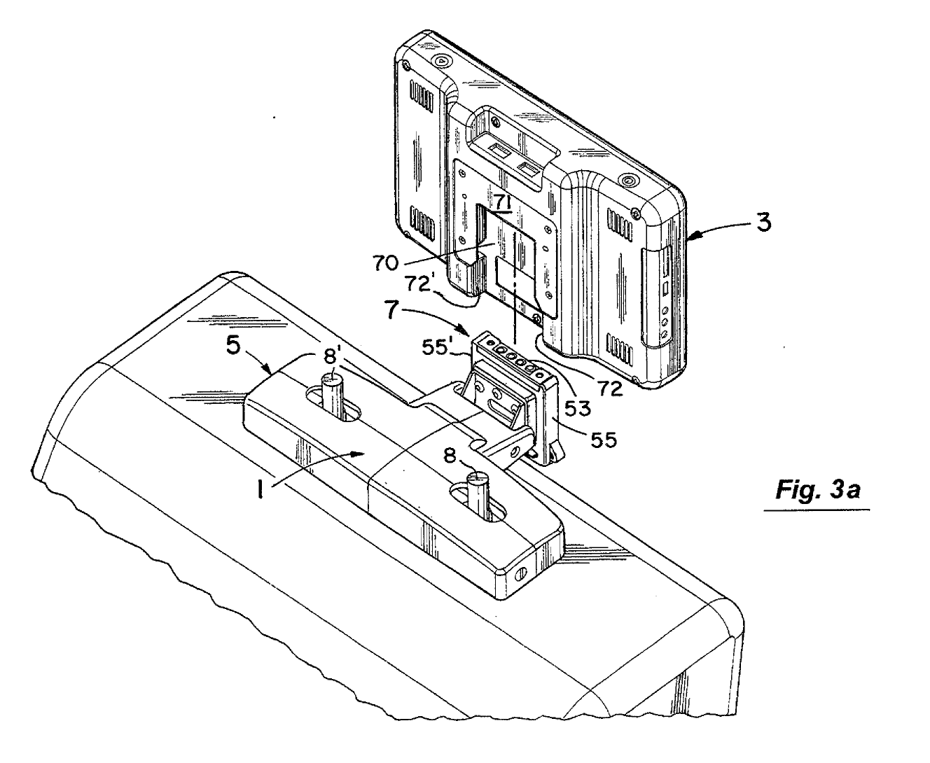

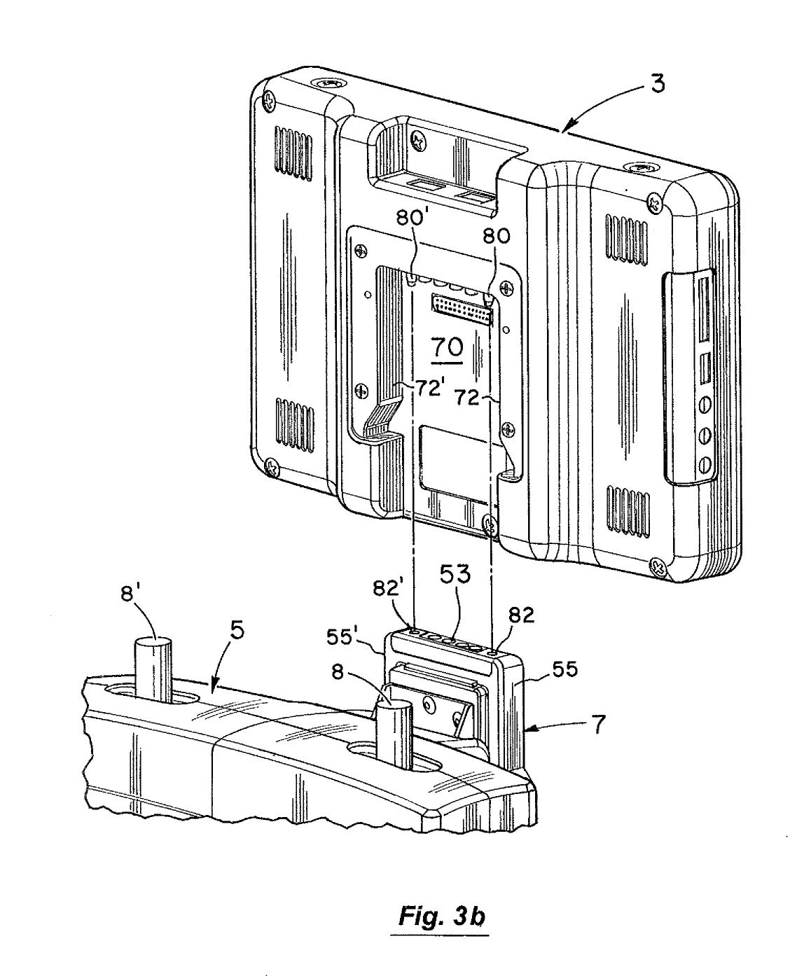

FIG. 1 illustrates the mounting system 1 of the present invention in use to support the rear-facing, entertainment module 3 on the upright posts of the automotive headrest 4. In FIG. 2, an opposite perspective view from FIG. 1 is shown with the padded section 6 of the headrest 4 of FIG. 1 removed for clarity. As explained in more detail below, the portable entertainment module 3 is releasably securable to the mounting system 1 and can be removed from the mounting system 1 (FIGS. 3a and 3b) to be stored or moved to another location or docking station. The module 3 can have a variety of entertainment uses such as digital VHF/UHF television, 3G Internet access, and DVD/CD/game player and can include a number of built-in antennas of different architectures and multiple types of power sources and connections.

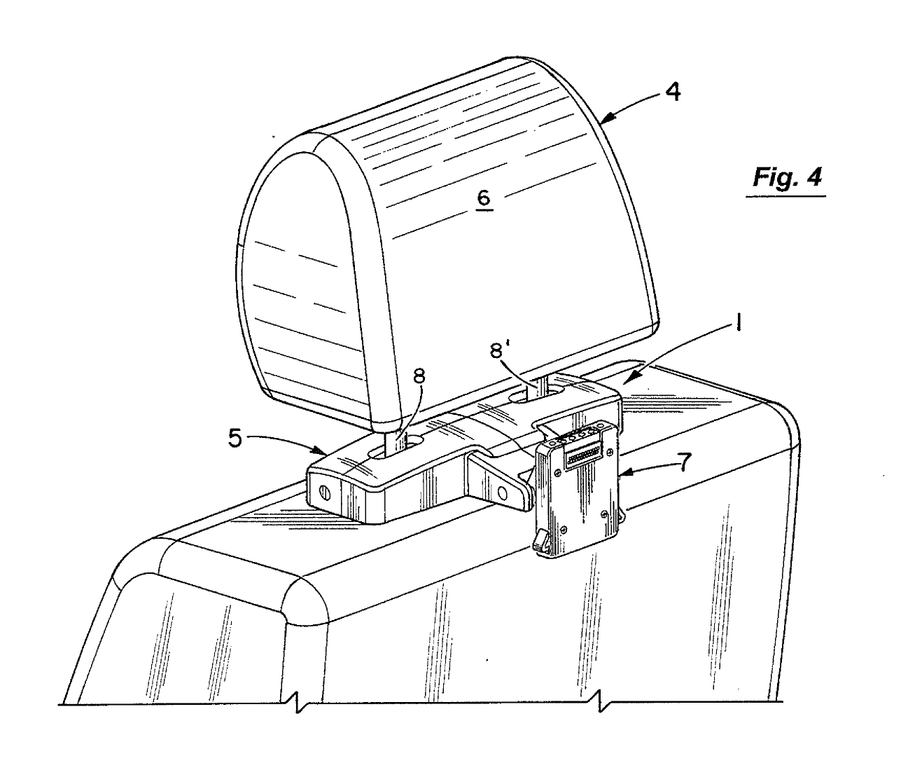

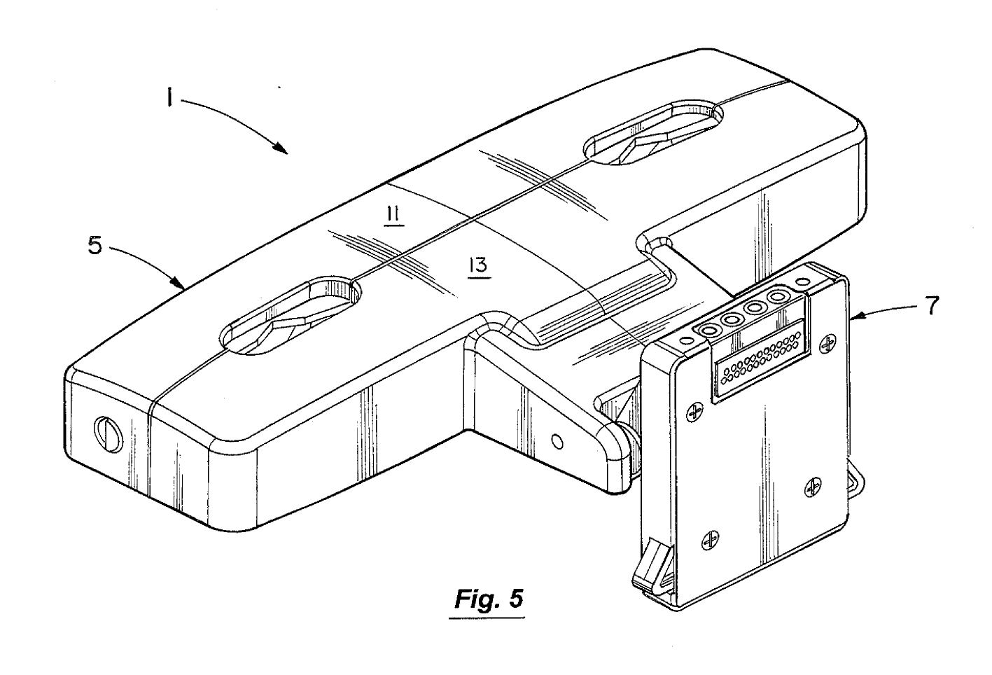

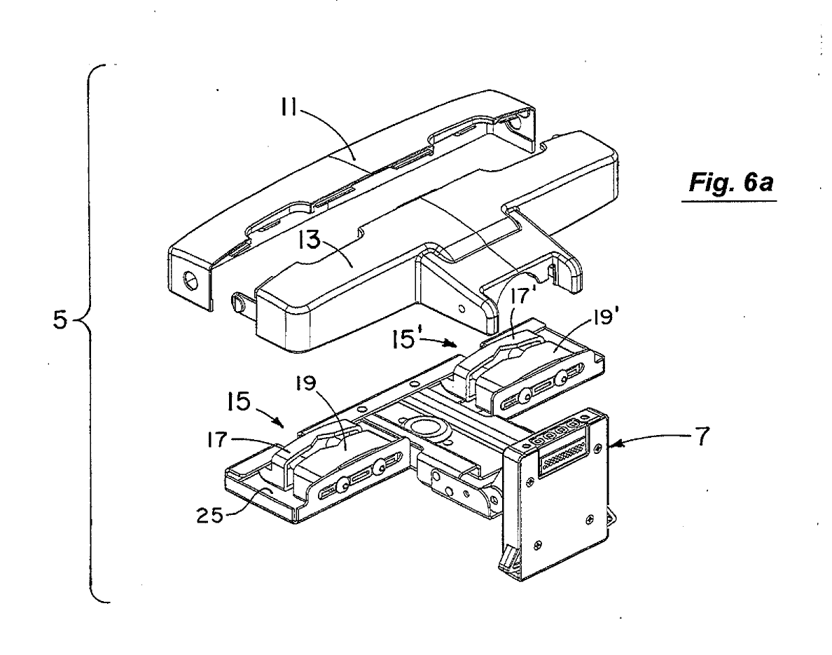

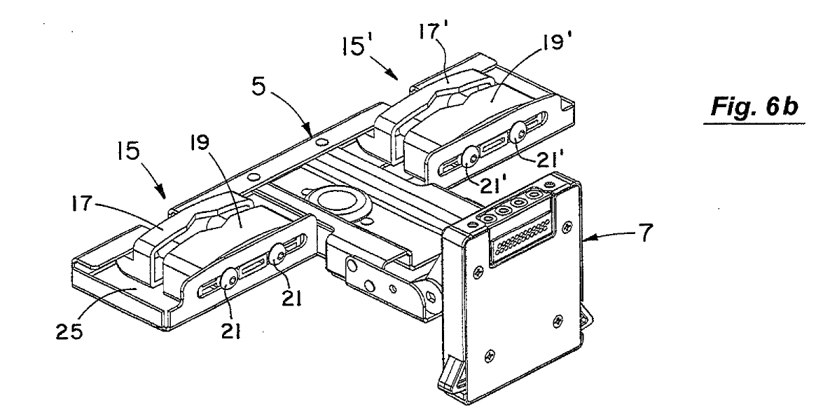

The mounting system 1 of the present invention has two principal sections 5,7 (see FIG. 4). The first section 5 is securable to the two upright posts 8,8′ of the headrest 4. In doing so, the front and rear covers 11,13 of the first section 5 in FIG. 5 can be removed (FIG. 6a) exposing the underlying pairs of clamping arrangements 15, 15′ on opposite ends of the base member 25 of the first section 5. Each pair of clamping arrangements 15,15′ in turn has first and second clamp members 17,19 and 17′,19′ (see also FIG. 6b).

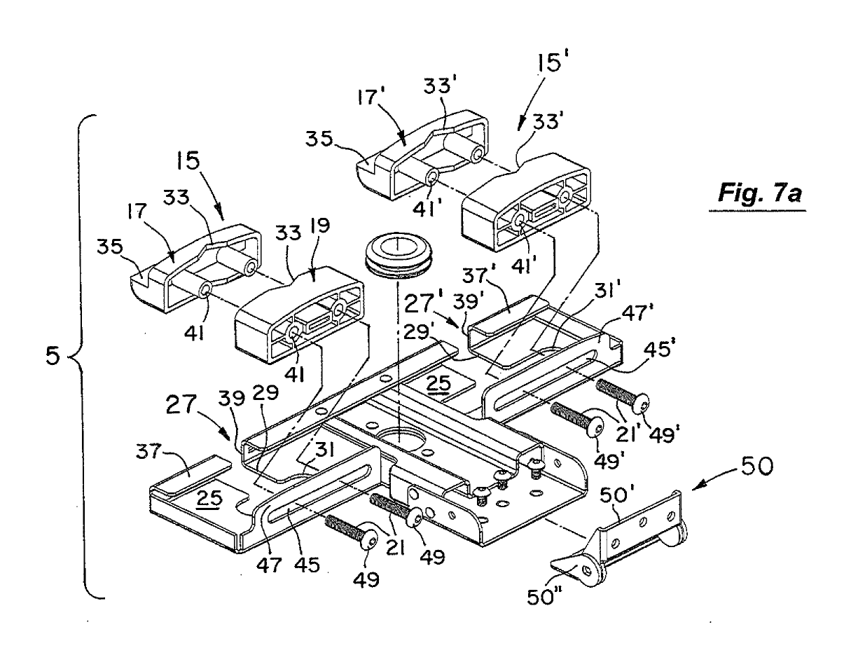

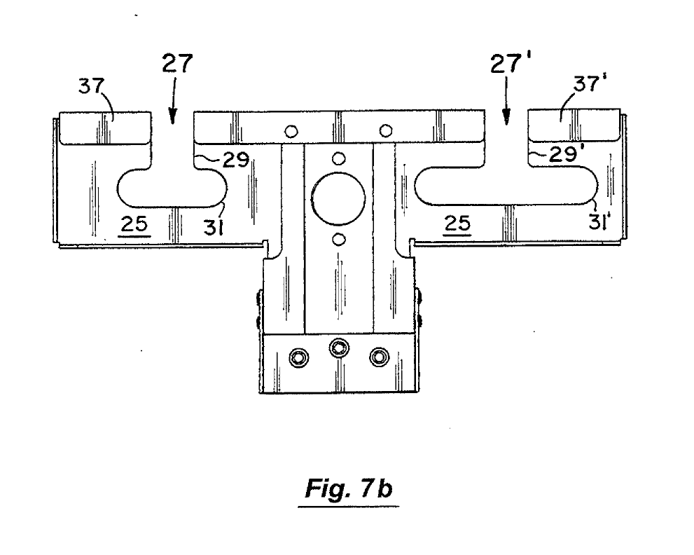

In operation, the threaded members 21,21′ (e.g., bolts or screws) associated with each clamping pair 15,15′ can be loosened and the clamp members 17,19 and 17′,19′ removed from the base plate member 25 as in the exploded view of FIG. 7a. The horizontally extending base member 25 of FIGS. 7a and 7b can then be manually manipulated to receive the vertically extending, upright posts 8,8′ of the headrest 4 in the respective T-shaped notches 27,27′(FIG. 7b) in the base plate member 25. The horizontally extending T-shaped notches 27, 27′ in this regard are designed so that the base member 25 can be used to fit a wide variety of arrangements of posts 8,8′ that may be spaced different distances apart (e.g., 110-170 millimeters center-to-center) in different vehicles. As for example and in vehicles with the substantially vertical posts 8,8′ spaced apart the same distance (e.g., 150 millimeters) as the stem portions 29,29′ of the T-shapes of FIG. 7b, the base member 25 can be moved essentially straight on or forward to slidably receive the posts 8,8′ in the stem portions 29,29′. Further movement of the base member 25 will then move the posts 8,8′ into the head portions 31,31′ of the T-shapes.

In other arrangements with the substantially parallel posts 8,8′ spaced closer or farther apart than the stem portions 29,29′, the base member can first be manipulated to receive one of the posts (e.g., 8) in a stem portion (e.g., 29) and into the head portion (e.g., 31). Thereafter, the base member 25 can be further moved to laterally position the post (e.g., 8) along the elongated head portion (e.g., 31). In this manner, the other post (e.g., 8′) can then be received in the other stem portion (29′) and moved into the other head portion (31′). The T-shapes can be symmetrical but as perhaps best seen in FIG. 7b, one of the head portions (e.g., 31′) is preferable elongated more than the other wherein the longer head portion (31′) enables the fitting of a wider variety of post arrangements.

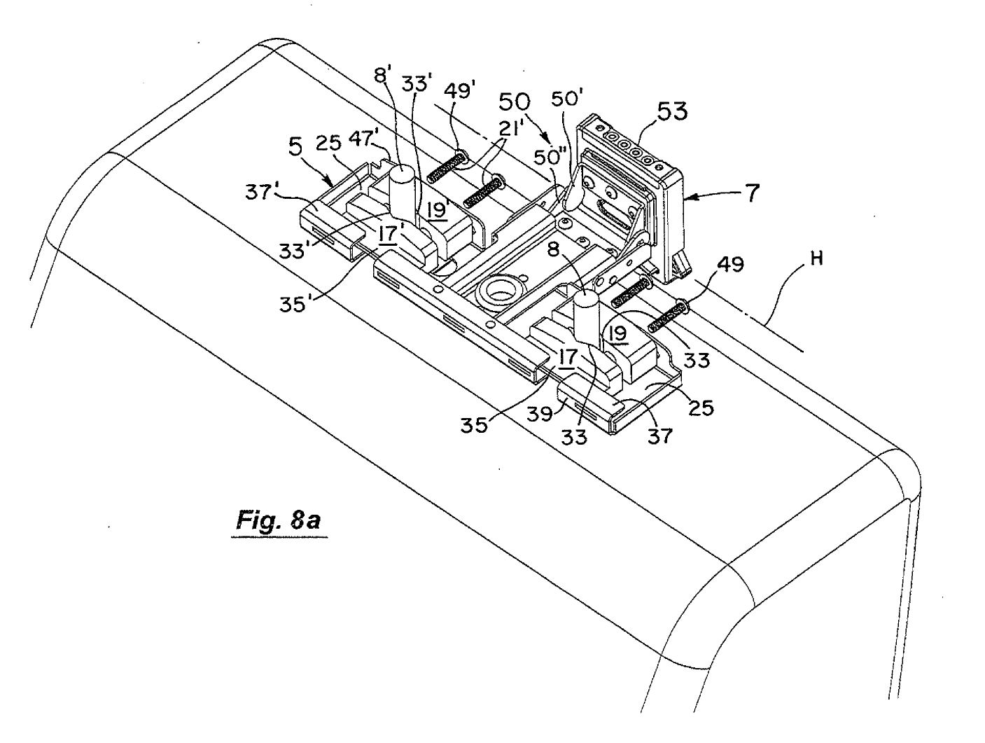

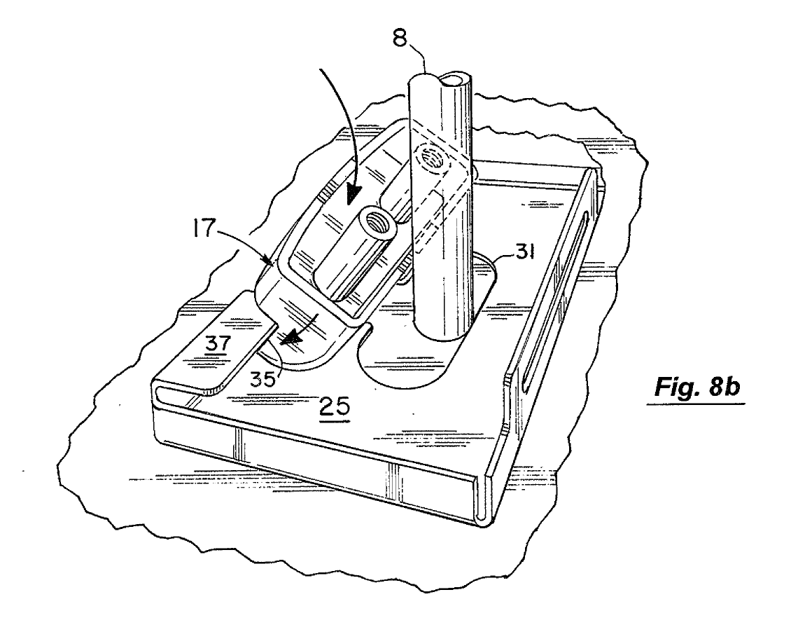

Regardless of the spacing of the post arrangement and once the posts 8,8′ are received in the respective head portions 31,31′ of the notches 27,27′, the clamp members 17,19 and 17′,19′ of each clamping pair 15,15′ can be positioned as in FIG. 8a. In this position, the clamp members 17,19 and 17′,19′ straddle the posts 8,8′ with the notches 33,33′ (see also FIG. 7a) in the facing sides of the clamp members 17,19 and 17′,19′ receiving the respective posts 8,8′ therebetween (see again FIG. 8a). In so positioning the clamp members 17,19 and 17′,19′, the clamp members are preferably first manipulated as in FIG. 8b to place the lip portions 35,35′ of the clamp members 17,17′ (see FIGS. 8a and 8b) under the respective ledge or catch pieces 37,37′ attached to the base member 25 (FIG. 8a). The lip portions 35,35′ (FIG. 8a) are then restrained or captured in the C-shapes formed by the horizontally extending ledge portions 37,37′ and base plate member 25 and the vertical wall sections 39,39′ extending between the base member and ledge portions.

The threaded members 21,21′ of FIG. 8a are receivable in the respective channels 41,41′ of the clamp members 17,19, and 17′,19′ (see FIG. 7a). With the clamp members positioned on opposing sides and straddling the posts 8,8′ as in FIG. 8a, the threaded members 21,21′ can then be tightened. This will draw the respective clamp members 17,19 and 17′,19′ toward each other with the respective posts 8,8′ therebetween. The threaded members 21,21′ (see FIGS. 7a and 8a) respectively pass through the slots 45,45′ (FIG. 7a) in the wall sections 47,47′ that extend upwardly from the horizontal plate member 25. As the threaded members 21,21′ are tightened, the heads 49,49′ of the threaded members 21,21′ engage the respective wall sections 47,47′. In this manner, the clamp members 17,19 and 17′,19′ and base plate member 25 and in turn the first section 5 of the mounting system 1 can be secured in a fixed position relative to the upright posts 8,8′ of the headrest 4.

The slots 45,45′ in the upstanding wall sections 47,47′ are horizontally elongated as shown in FIG. 7a. In cooperation with the T-shaped notches 27,27′ in the base plate member 25, the base member 25 and first section 5 of the mounting system 1 can then be secured to a wide variety of automotive arrangements in which the posts 8,8′ are spaced at different distances from each other. Additionally, the base member 25 and first section 5 can usually be slightly adjusted or horizontally slid relative to the posts 8,8′ prior to being securely tightened in place by the clamp members 17,19 and 17′,19′ of arrangements 15,15′. In this manner, the positioning of the entertainment module 3 of FIG. 1 can be adjusted to a certain degree horizontally relative to the headrest 4 for best viewing by the user.

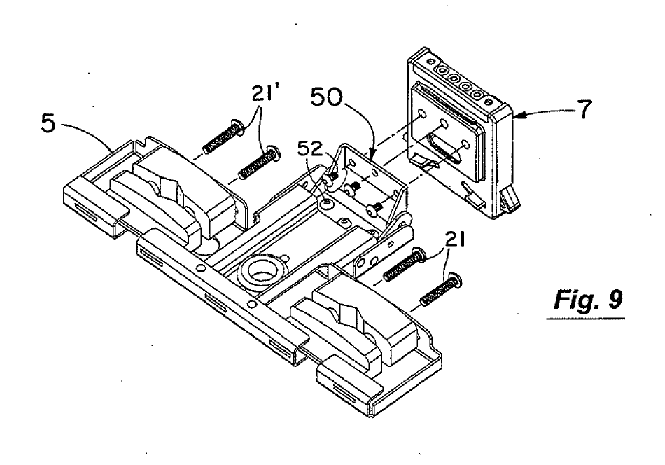

The second section 7 of the system 1 as indicated above is mounted to the first section 5 for pivotal movement about the substantially horizontal axis H of FIG. 8a. This can be done in any number of manners including by the bracket 50 and nuts 52 of FIG. 9. The bracket 50 as perhaps best seen in FIG. 7a has first and second portions 50′,50″ which frictionally engage one another to hold the second section 7 in any desired, pivotal position.

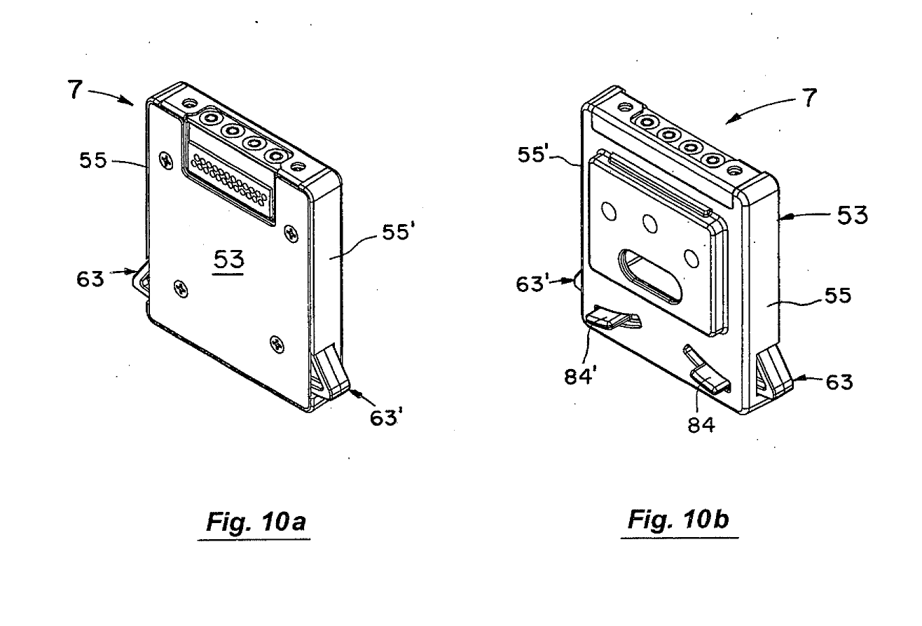

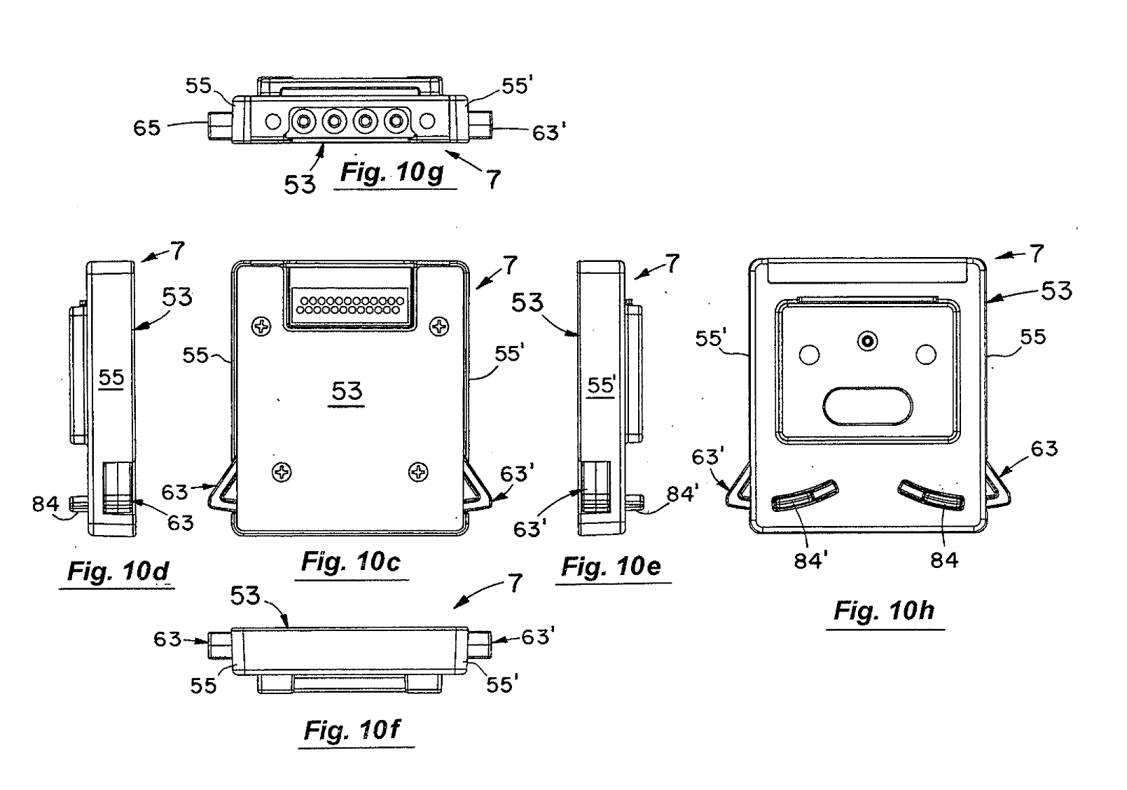

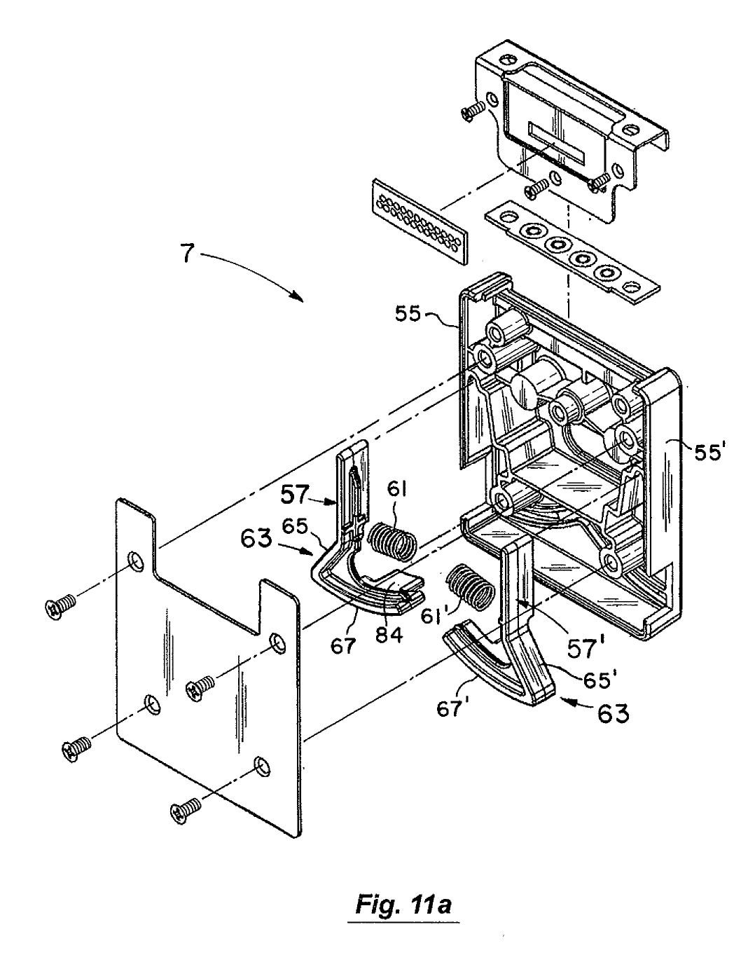

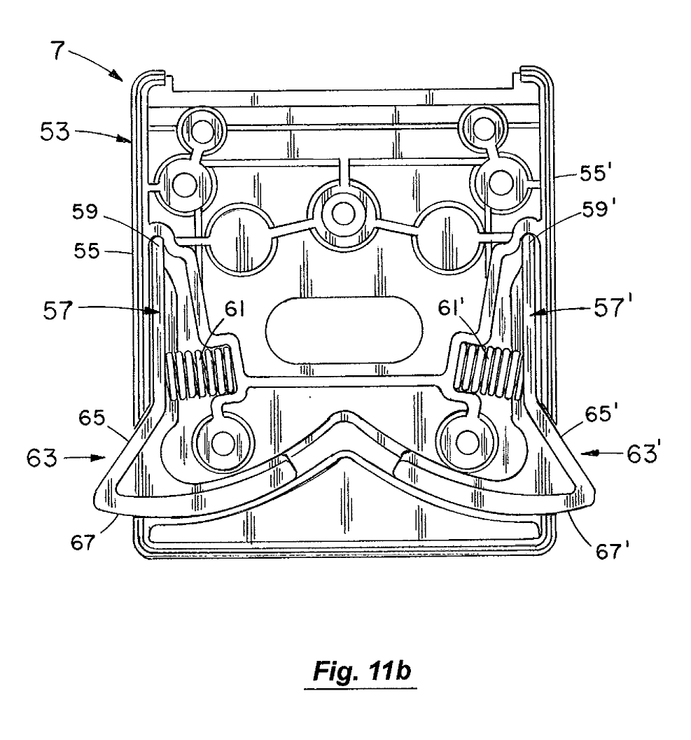

The second section 7 of the mounting system 1 is illustrated from all sides in FIGS. 10a-10h. The second section 7 in this regard has a housing 53 (FIGS. 10a-10c) with two substantially parallel sidewalls 55,55′ (FIG. 10c). Within the housing 53, two latch members 57,57′ (FIGS. 11a-11b) are mounted as best seen in FIGS. 11a-11b to pivot about respective axes at 59,59′ (FIG. 11b) which are substantially parallel to each other. Latch members 57,57′ as illustrated in FIG. 11b are respectively biased by springs 61,61′ outwardly away from each other to the extended positions of FIGS. 10a-10h and IIb. In these positions, the articulated elbow segments 63,63′ of the latch members 57,57′ extend at least in part outwardly beyond the sidewalls 55,55′ of the housing 53 as in FIGS. 10a-10h. The articulated segments 63,63′ in this regard as shown in FIGS. 11a-11b respectively have ramp sections 65,65′ and locking sections 67,67′. The ramp sections 65,65′ as illustrated are inclined (e.g., 45 degrees) to the sidewalls 55,55′ with the latch members 57,57′ in the extended positions and the locking sections 67,67′ similarly extend substantially perpendicular to the sidewalls 55,55′ with the latch members 57,57′ in the extended positions.

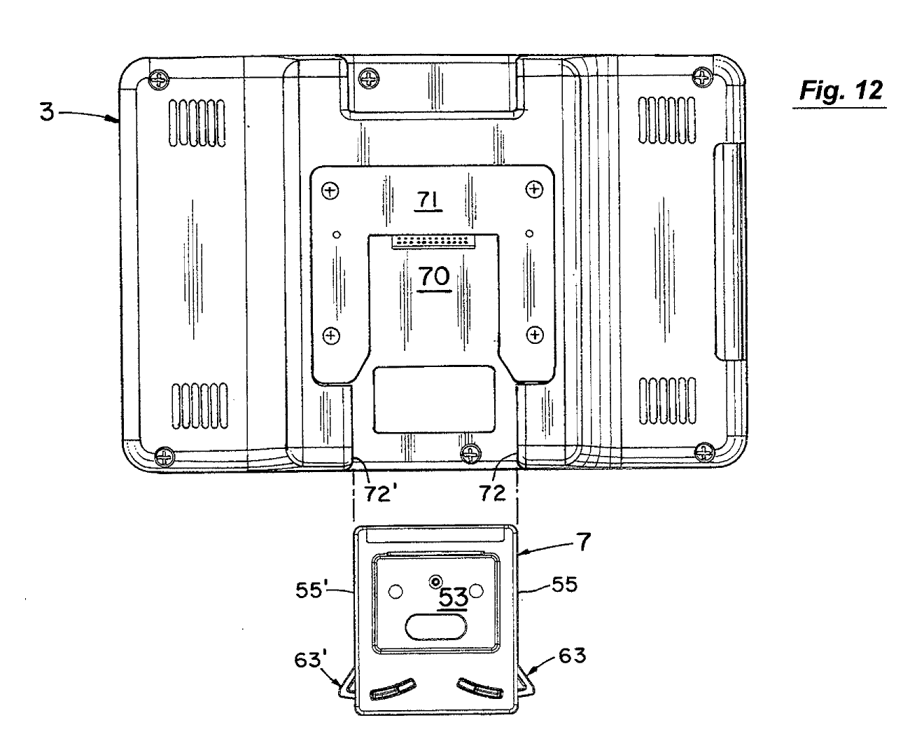

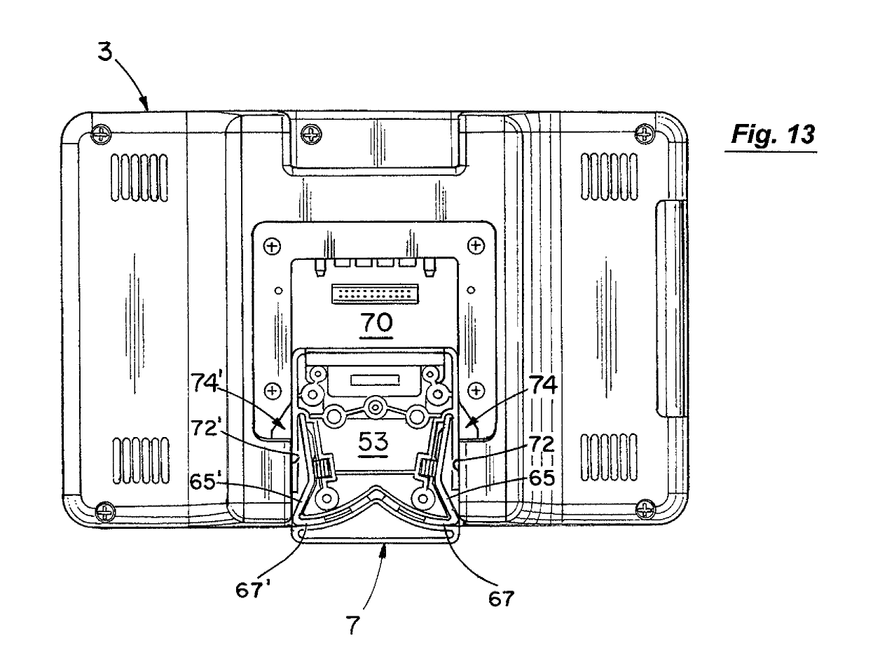

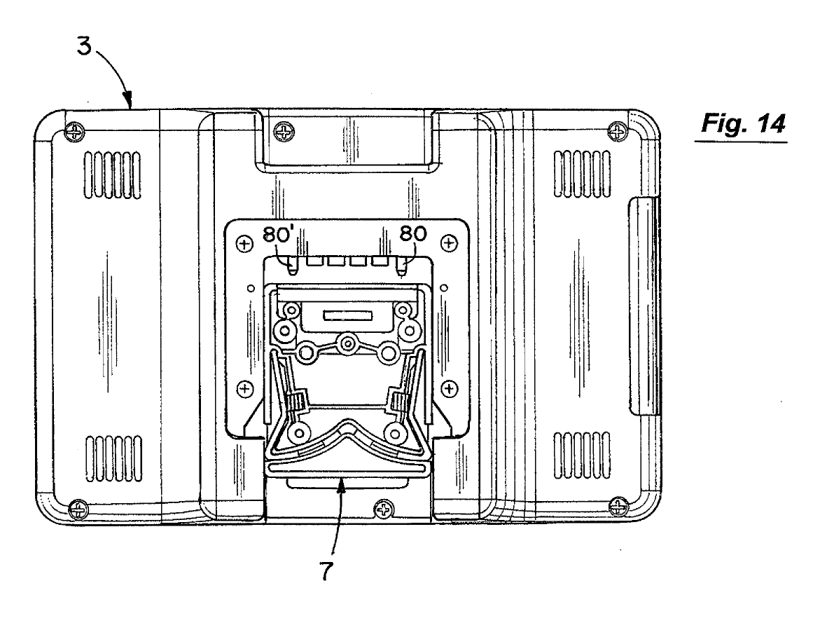

In use, the housing 53 of the second section 7 of the mounting system 1 operates as a male portion that is receivable in the female portion 70 of the entertainment module 3 (see FIGS. 2 and 3a-3b). The female portion 70 has two substantially parallel sidewalls 72,72′ (FIG. 12) that are spaced a first distance from each other. The corresponding sidewalls 55,55′ of the second section 7 of the mounting system 1 are then spaced a second distance from each other slightly less than this first distance. The articulated or elbow segments 63,63′ of the latch members 57,57′ in turn extend outwardly of each other for a third distance (FIG. 12) in the extended positions greater than the first and second distances. In this manner and as the entertainment module 3 is lowered in a first direction along an axis onto the second or male section 7 (see FIGS. 13-15 which have the cover plate 71 of FIG. 12 removed for clarity), the sidewalls 72,72′ of the female portion 70 on the entertainment module 3 will contact or strike the inclined ramp sections 65,65′ of the latch members 57,57′ and move the latch members 57,57′ toward retracted positions (FIGS. 13-14). The sidewalls 72,72′ in this regard have recessed areas 74,74′ (FIG. 13) corresponding to the articulated or elbow segments 63,63′ of the latch members 57,57′.

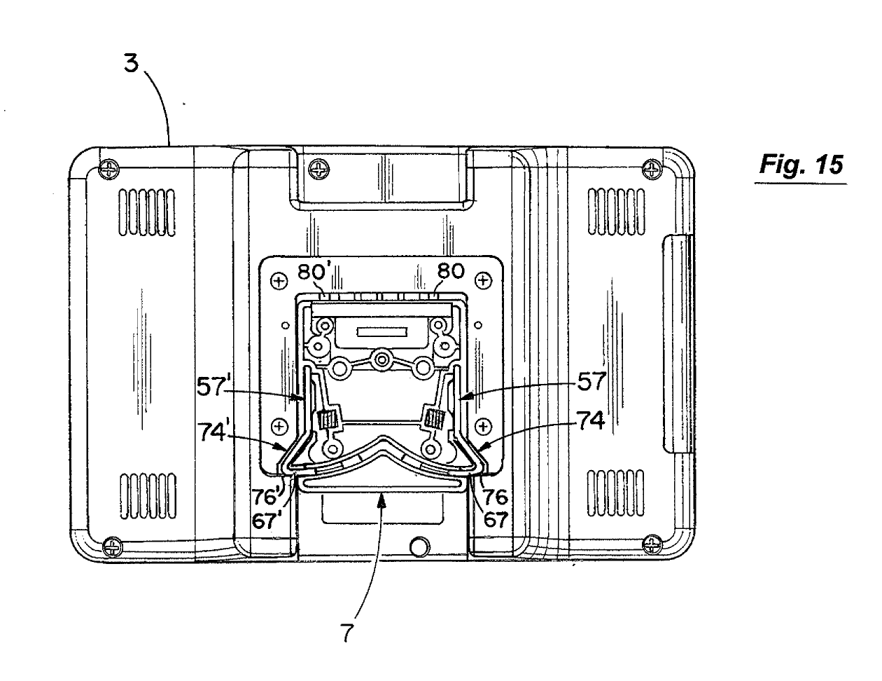

Consequently and once the articulated segments 63,63′ are aligned with the recessed areas 74,74′ as in FIG. 15, the spring biased latch members 57,57′ will be moved to engage the articulated segments 63,63′ (FIG. 15) in the recessed areas 74,74′ to lock the entertainment module 3 in a predetermined, operating position on the housing 53 of the second section 7. In this position, the electrical connectors are coupled and the entertainment module 3 is ready for use. Additionally, the locking segments 67,67′ of the latch members 57,57′ (FIG. 15) are engaged and substantially aligned with the corresponding locking segments 76,76′ of the recessed areas 74, 74′. These components of the second section 7 and entertainment module 3 in this regard then serve to form a latching arrangement to secure the entertainment module 3 in its predetermined, operating position relative to the second section 7 of the mounting system 1. To assist in pivoting the module 3 and mated section 7 of the mounting system 1, protruding pegs 80,80′ can be provided adjacent the female portion 70 of the module 3 to engage mating recesses 82,82′ in the second or male section 7 (see also FIGS. 14-15). Additionally, the inverted, U-shaped cover plate 71 of FIGS. 2, 3a, and 12 will overlap or overlay portions of the sidewalls 55, 55′ and top wall of the housing 53 to further aid in holding the housing 53 in place. In this manner, the mounted module 3 can be easily and quickly gripped and pivoted to the desired viewing angle moving the housing 53 and second section 7 of the mounting system 1 with it.

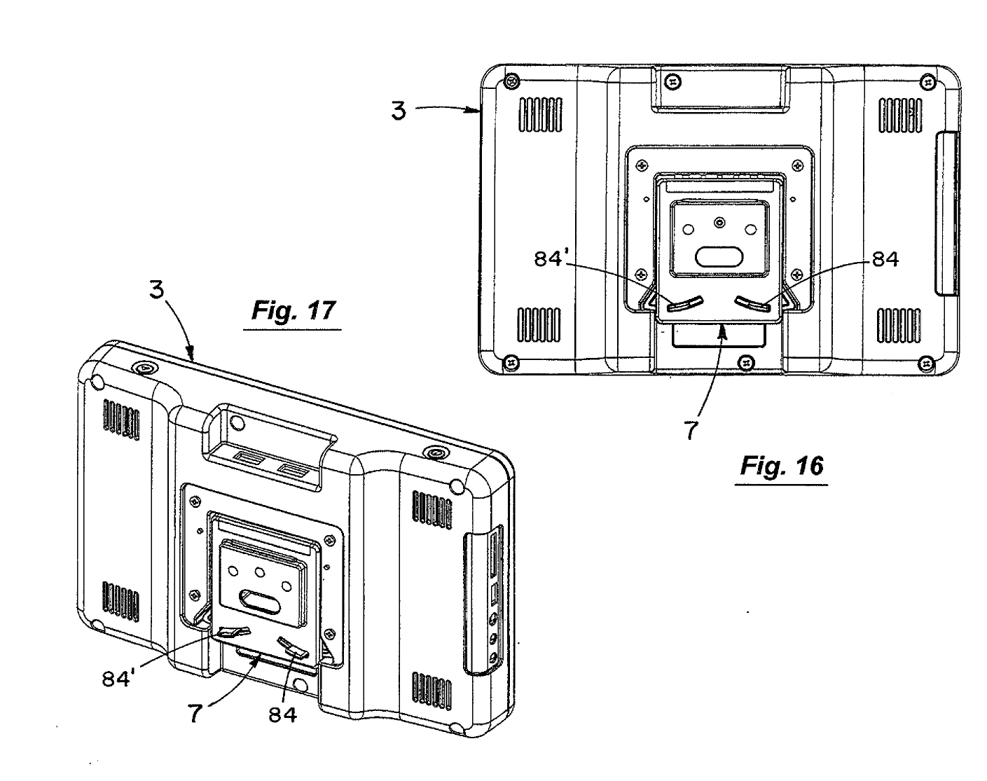

To release the module 3 from the mounting system 1, the release sections 84,84′ of the latch members 57,57′ extending outwardly of the back of the housing 53 of the second section 7 (see FIGS. 10b, 10h, and 16) can be manually engaged and squeezed or moved toward each other. This in turn will move the spring-biased latch members 57,57′ of FIG. 15 to their retracted positions into the housing 53 with the locking segments 67,67′ of latch members 57,57′ disengaged from the corresponding segments 76,76′ of the recessed areas 74,74′. The module 3 can then be lifted up in a direction opposite to the sequence of FIGS. 12-15 to remove the module 3 from the mounting system 1.

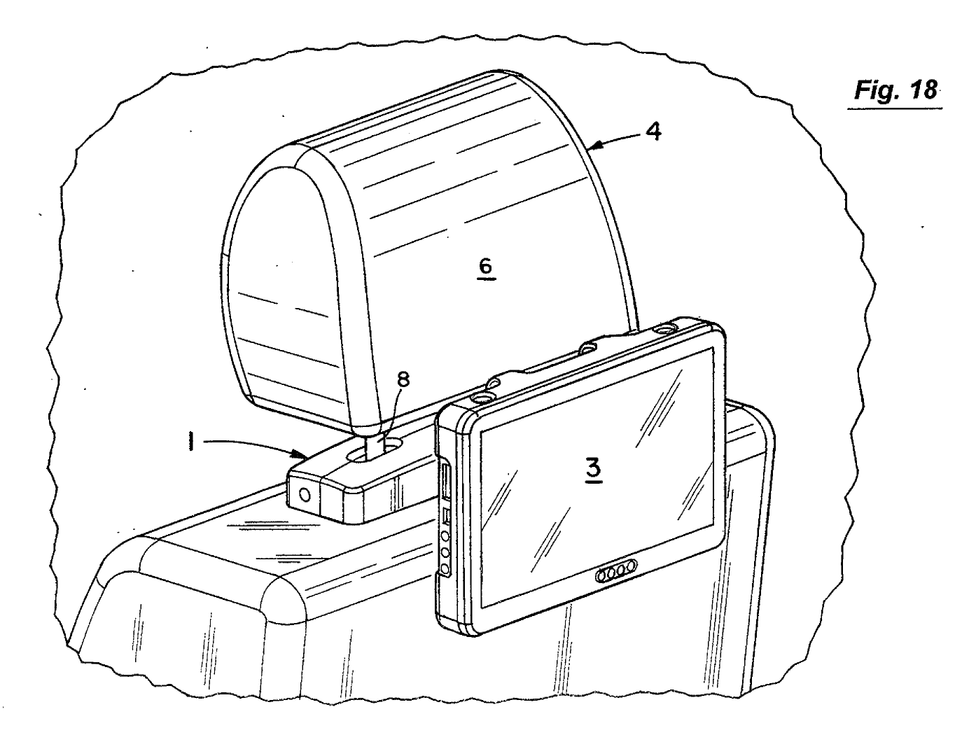

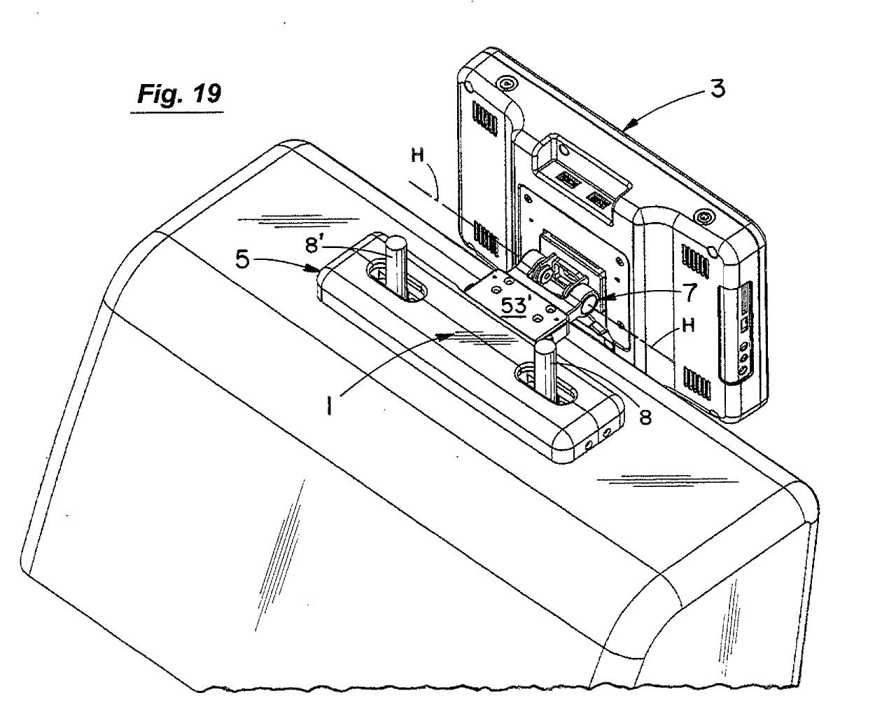

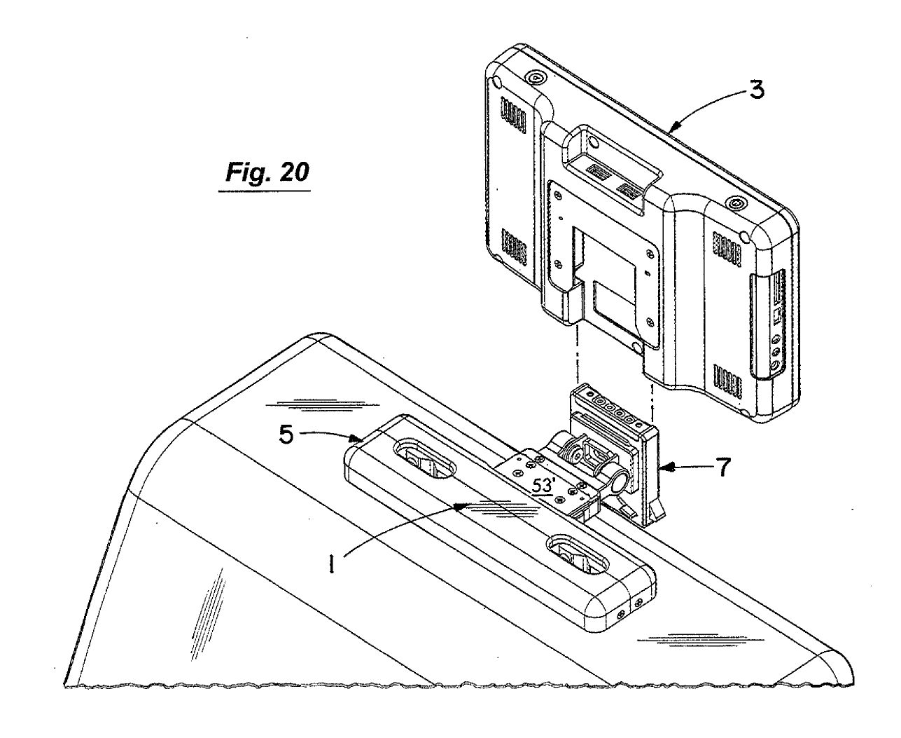

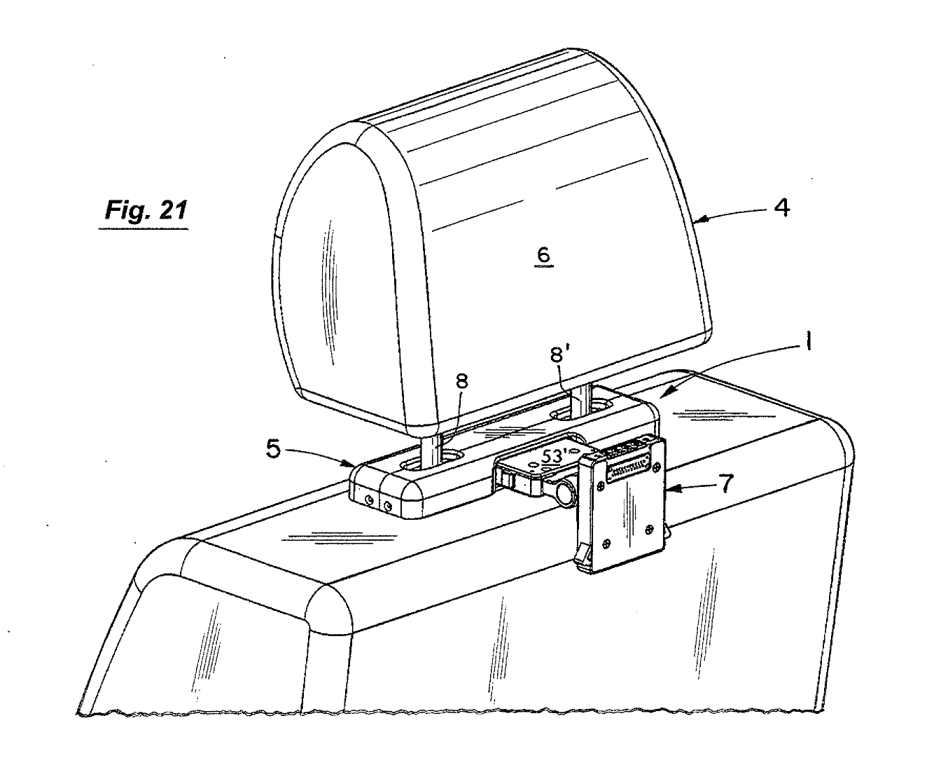

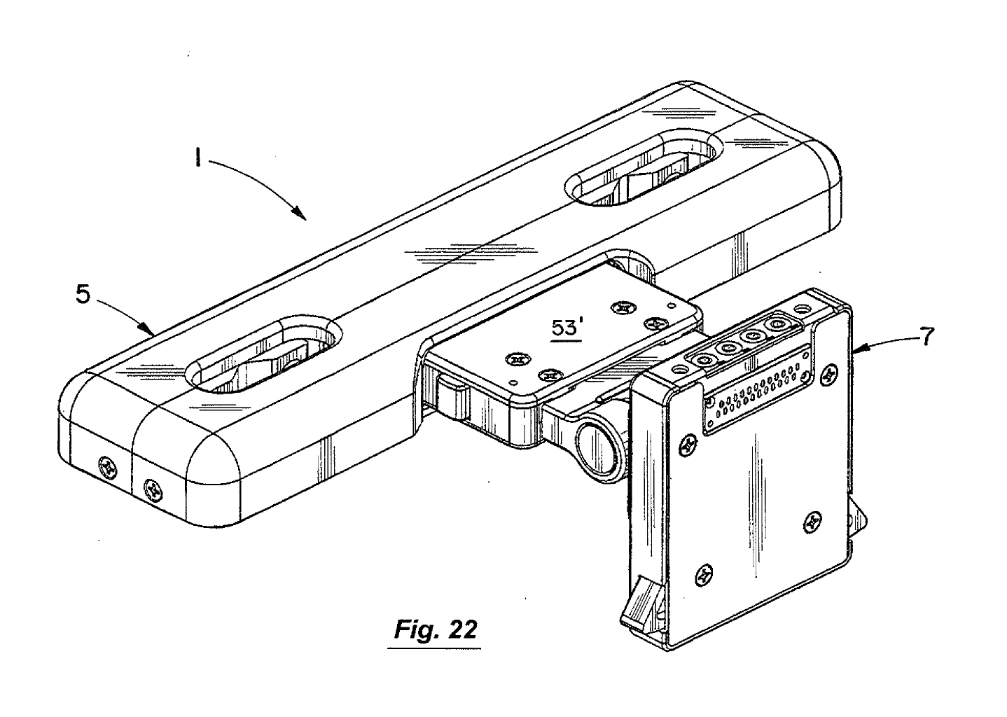

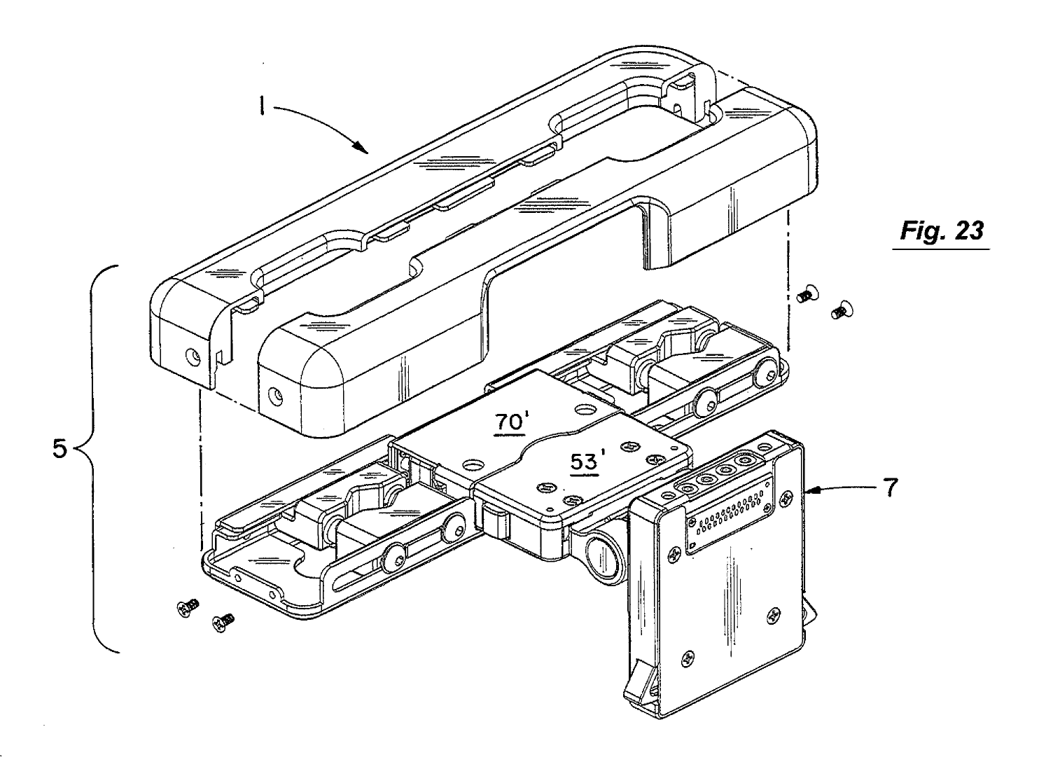

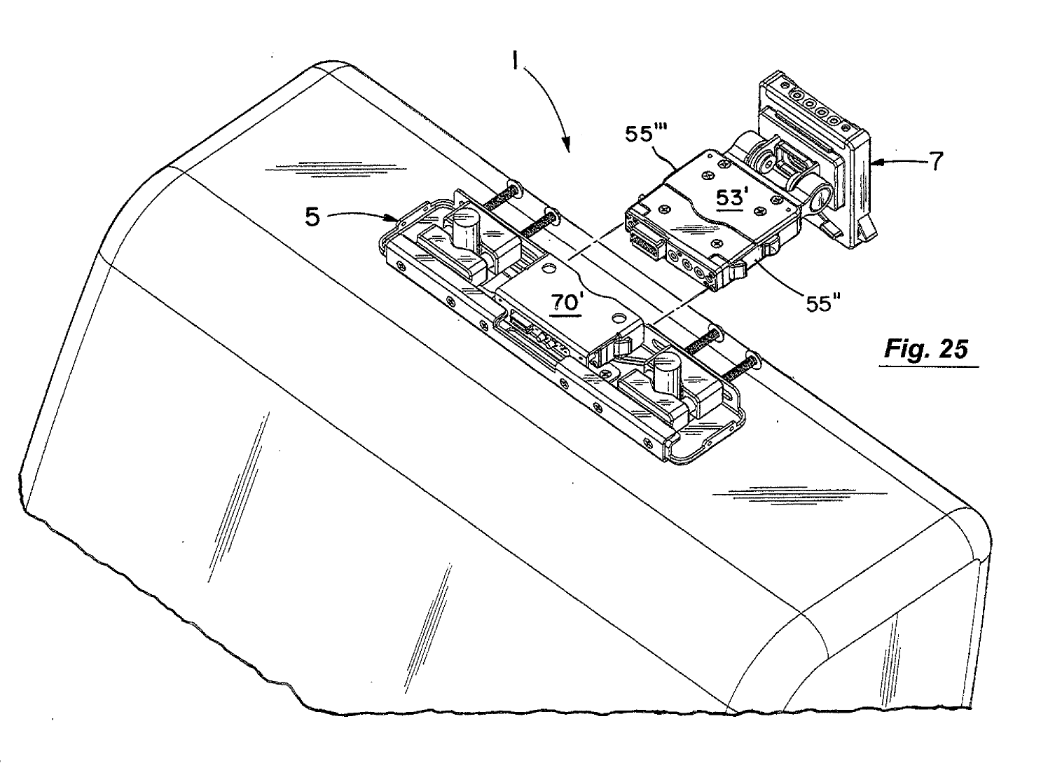

FIGS. 18-27b illustrate a second embodiment of the present invention. Like the first embodiment of FIGS. 1-17, the second section 7 of the second embodiment is mounted for pivotal movement about the substantially horizontal axis H (FIG. 19) relative to the first section 5 and the entertainment module 3 is releasably attached to the second section 7 (FIG. 20). However, unlike the first embodiment in which the first and second sections 5,7 are integral with each other, the first and second sections 5,7 of the second embodiment are releasably securable to each other by a latching arrangement. This latching arrangement includes the male portion 53′(FIGS. 19-22) of the second section 7 and the female portion 70′ (FIGS. 23-25) of the first section 5.

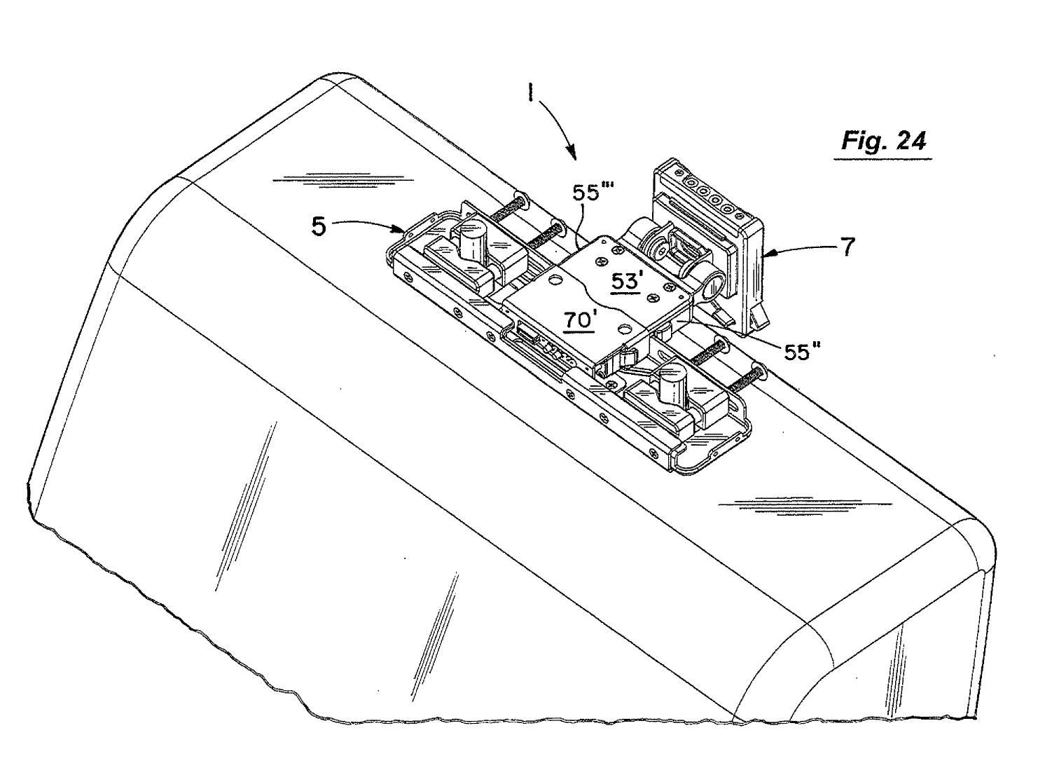

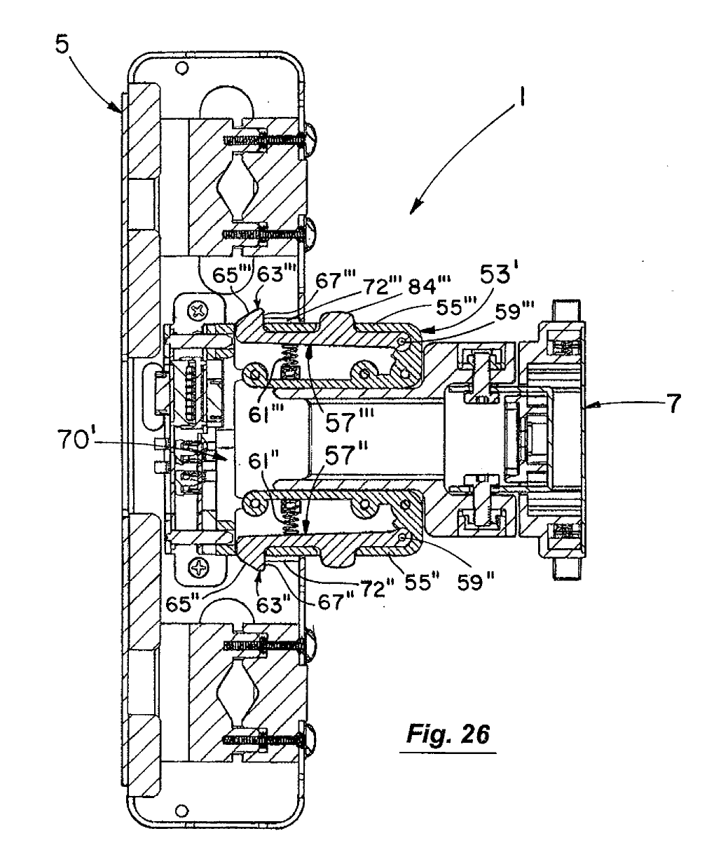

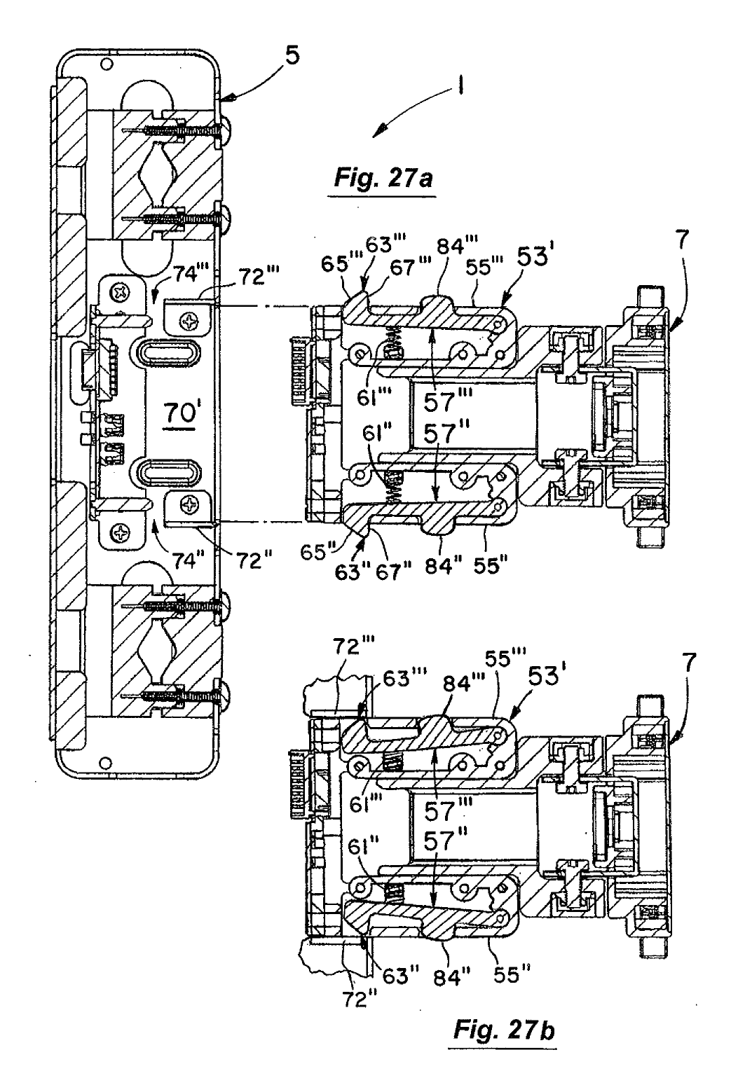

More specifically, the second section 7 of the second embodiment has a housing 53′ with two substantially parallel sidewalls 55″,55′″ (FIGS. 24-27a). Within the housing 53′, two latch members 57″,57′″ (FIGS. 26-27a) are mounted to pivot about respective axes at 59″,59′″ (FIG. 26) which are substantially parallel to each other. Latch members 57″,5T′″ as illustrated in FIG. 26 are respectively biased by springs 61″,61′″ outwardly away from each other to the extended positions of FIG. 26. In these positions, the segments 63″,63′″ of the latch members 57″,57′″ extend at least in part outwardly beyond the sidewalls 55″,55′″ of the housing 53′ as in FIGS. 26 and 27a. The segments 63″,63′″ in this regard as shown in FIGS. 26 and 27a respectively have ramp sections 65″,65′″ and locking sections 67″,67′″. The ramp sections 65″,65′″ as illustrated are inclined (e.g., 45 degrees) to the sidewalls 55″,55′″ with the latch members 57″,57′″ in the extended positions and the locking sections 67″,67′″ similarly extend substantially perpendicular to the sidewalls 55″,55′″ with the latch members 57″,57′″ in the extended positions.

In use, the housing 53′ of the second section 7 of the mounting system 1 operates as a male portion (see FIG. 27a) that is receivable in the female portion 70′ of the first section 5 (see FIGS. 23-26). The female portion 70′ has two substantially parallel sidewalls 72″,72′″ as perhaps best seen in FIG. 27a that are spaced a first distance from each other. The corresponding sidewalls 55″,55′″ of the housing 53′ of the second section 7 of the mounting system 1 are then spaced a second distance from each other slightly less than this first distance. The segments 63″,63′″ of the latch members 57″,57′″ in turn extend outwardly of each other for a third distance (FIG. 27a) in the extended positions greater than the first and second distances. In this manner and as the housing 53′ of the second section 7 is moved in a first direction along an axis into the female portion 70′ of the first section 5 (i.e., from the position of FIG. 27a to the position of FIG. 26), the sidewalls 72″,72′″ will contact or strike the inclined ramp sections 65″,65′″ of the latch members 57″,57′″ and move the latch members 57″,57′″ toward retracted positions (FIG. 27b). The sidewalls 72″,72′″ in this regard have recessed areas or openings 74″,74′″ (FIG. 27a) corresponding to the segments 63″,63′″ of the latch members 57″,57′″.

Consequently and once the segments 63″,63′″ are aligned with the recessed areas or openings 74″,74′″ of FIG. 27a, the spring biased latch members 57″,57′″ will be moved to engage the segments 63″,63′″ (FIG. 26) in the recessed areas 74″,74′″ to lock the second section 7 in a predetermined, operating position on the first section 5 via the housing 53′ of the second section 7. In this position, the electrical connectors are coupled as between the first and second sections 5,7. Additionally, the locking segments 67″,67′″ of the latch members 57″,57′″ (FIGS. 26 and 27a) are engaged and substantially aligned with the corresponding locking segments or left edges of the sidewalls 72″,72′″ (FIG. 26) of the female portion 70′ at the recessed areas 74″,74′″. These components of the second section 7 and the first section 5 in this regard then serve to form a latching arrangement to secure the second section 7 in its predetermined, operating position relative to the first section 5 of the mounting system 1.

To release the second section 7 from the first section 5, the release sections 84″,84′″ of the latch members 57″,57′″ extending outwardly of the sidewalls 55″,55′″ of the housing 53′ of the second section 7 (see FIGS. 26-27b) can be manually engaged and squeezed or moved toward each other. This in turn will move the spring-biased latch members 57″,57′″ of FIG. 27b to their retracted positions into the housing 53′ with the locking segments 67′,67′″ of latch members 57″,57′″ disengaged from the corresponding segments or left edges of the sidewalls 72″,72′″ at the recessed areas 74″,74′″ of FIG. 26. The second section 7 can then be moved in a direction opposite to the engaging sequence (i.e., moved from the position of FIG. 26 to the position of FIG. 27a) to remove the second section 7 from the first section 5.

In the second embodiment of FIGS. 18-27b, the second section 7 thus has two latching arrangements at 53,53′ to respectively and removably secure or attach the second section 7 to the first section 5 at 53′ and to the entertainment module 3 at 53. The two latching arrangements 53,53′ are then frictionally and pivotally attached to each other for movement about the substantially horizontal axis H of FIG. 19 whereby the entertainment module 3 as in the first embodiment can be easily and quickly gripped and pivoted to the desired viewing angle moving the housing 53 of the second section 7 of the mounting system 1 with it.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims. In particular, it is noted that the word substantially is utilized herein to represent the inherent degree of uncertainty that may be attributed to any quantitative comparison, value, measurement or other representation. This term is also utilized herein to represent the degree by which a quantitative representation may vary from a stated reference without resulting in a change in the basic function of the subject matter involved.

We claim:

1. A mounting system (1) for releasably securing a rear-facing, entertainment module (3) to an automotive headrest (4), the headrest having two upright posts (8,8′) extending substantially vertically and parallel to each other, said mounting system including:
first and second sections (5,7), said first section (5) being securable to the two upright posts (8,8′) of said automotive headrest and said second section (7) being secured to said first section (5),
said second section (7) being releasably securable to said entertainment module (3) by a latching arrangement, said latching arrangement having mating male and female portions (53,70), said male portion (53) including first and second latch members (57,57′) respectively mounted for pivotal movement about first and second pivotal axes (59,59′) between retracted and extended positions, said first and second axes being substantially parallel to each other and each of said first and second latch members (57,57′) being biased outwardly away from each other and away from the respective retracted positions and toward the respective extended positions,
said female portion (70) of the latching arrangement having substantially parallel sidewalls (72,72′) spaced for each other a first distance and said male portion (53) having substantially parallel sidewalls (55,55′) spaced from each other a second distance less than said first distance, said male portion (53) being receivable in said female portion (70) with the respective sidewalls of the male and female portions substantially adjacent one another, said sidewalls (72,72′) of the female portion including respective recessed areas (74,74′) to respectively receive at least portions of the latch members (57,57′) therein with the latch members in the extended positions, said latch members in the extended positions having respective segments (63,63′) thereof extending outwardly beyond the respective sidewalls (55,55′) of the male portion (53) and into the respective recessed areas (74,74′) of said female portion (70) to latch the entertainment module (3) to the second section (7) of said mounting system (1) in a predetermined, operating position relative thereto.

2. The mounting system of claim 1 wherein said first and second sections (5,7) of said mounting system (1) are mounted to each other for pivotal movement relative to each other about a substantially horizontal axis (H).

3. The mounting system of claim 1 wherein the segments (63,63′) of said latch members (57,57′) in the extended positions respectively extend outwardly of each other a third distance greater than the first distance the sidewalls (72,72′) of said female portion (70) are spaced from each other.

4. The mounting system of claim 3 wherein the respective segments (63,63′) of the latch members (57,57′) have respective ramp sections (65,65′) inclined to the respective sidewalls (55,55′) of the male portion (53) wherein the respective sidewalls (72,72′) of the female portion (70) as the male portion is received therein strike the inclined ramp sections and pivot the respective latch members away from the extended positions and toward the retracted positions to allow the respective sidewalls (72,72′) of the female portion to pass by the respective latch members (57,57′).

5. The mounting system of claim 4 wherein the respective segments (63,63′) of the latch members (57,57′) have locking sections (67,67′) adjacent the ramp sections and extending substantially perpendicular to the respective sidewalls (55,55′) of the male portion (53) with the latch members in said extended positions, said respective recessed areas (74,74′) of the respective sidewalls (72,72′) of the female portion (70) having corresponding locking sections (76,76′) extending substantially perpendicular to the respective sidewalls (72,72′) of the female portion wherein the respective locking sections of the latch members and recessed areas substantially engage one another to secure the male and female portions (53,70) in a locked position with the entertainment module (3) in the predetermined, operating position relative to the second section (7) of the mounting system (1).

6. The mounting system of claim 5 wherein the respective sidewalls (72,72′) of the female portion (70) strike the inclined ramp sections (65,65′) and pivot the respective latch members (57,57′) toward the retracted positions as the male portion (53) is received in the female portion (70) and moved along an axis in a first direction relative to the female portion, said engaging locking sections of said latch members and recessed areas preventing movement of the male portion relative to the female portion along said axis in a direction opposite to said first direction.

7. The mounting system of claim 6 further including a release mechanism to release said male and female portions from said locked position.

8. The mounting system of claim 7 wherein said release mechanism includes respective release sections (84,84′) on the latch members wherein the release sections can be manually engaged and moved toward each other to move the latch members (57,57′) toward the respective retracted positions to release the locking sections of the latch members (57,57′) of the male portion and the recessed areas (74,74′) of the female portion from engagement to allow the female portion to be moved along said axis in said direction opposite to the first direction to remove the entertainment module (3) from the second section (7) of the mounting system (1).

9. The mounting system of claim 4 wherein the entertainment module (3) adjacent the female portion (70) thereof further includes a cover plate (71) overlapping at least portions of the side walls (55,55′) of the male portion (53) with the male and female portions (53,70) in said locked position.

10. The mounting system of claim 9 wherein the male portion has a top side and the cover plate (71) has an inverted U-shape overlapping at least a portion of the top side.

11. The mounting system of claim 10 wherein the entertainment module (3) adjacent the female portion (70) thereof has at least one peg (80) receivable in a recess (82) in the male portion (53) with the male and female portions (53,70) in said locked position.

12. The mounting system of claim 1 wherein said second section (7) is releasably securable to said first section (5) by a latching arrangement, said latching arrangement having mating male and female portions (53′,70′), said male portion (53′) including first and second latch members (57″,57′″) respectively mounted for pivotal movement about first and second pivotal axes (59″,59′″) between retracted and extended positions, said first and second axes being substantially parallel to each other and each of said first and second latch members (57″,57′″) being biased outwardly away from each other and away from the respective retracted positions and toward the respective extended positions,
said female portion (70′) of the latching arrangement having substantially parallel sidewalls (72″,72′″) spaced for each other a first distance and said male portion (53′) having substantially parallel sidewalls (55″,55′″) spaced from each other a second distance less than said first distance, said male portion (53′) being receivable in said female portion (70′) with the respective sidewalls of the male and female portions substantially adjacent one another, said sidewalls (72″,72′″) of the female portion including respective recessed areas (74″,74′″) to respectively receive at least portions of the latch members (57″,57′″) therein with the latch members in the extended positions, said latch members in the extended positions having respective segments (63″,63′″) thereof extending outwardly beyond the respective sidewalls (55″,55′″) of the male portion (53′) and into the respective recessed areas (74″,74′″) of said female portion (70′) to latch the first section (5) to the second section (7) of said mounting system (1) in a predetermined, operating position relative thereto.

13. A mounting system (1) for releasably securing a rear-facing, entertainment module (3) to an automotive headrest (4), the headrest having two upright posts (8,8′) extending substantially vertically and parallel to each other, the mounting system including:
first and second sections (5,7), said first section (5) being securable to the two upright posts (8,8′) of the headrest in a fixed position relative thereto and said second section (7) being releasably securable to said entertainment module (3),
said first section (5) having a substantially horizontally extending base member (25), said base member having first and second, substantially horizontally extending notches (27,27′) to slidably receive the respective upright posts (8,8′) of the headrest therein, said first section (5) further including a pair of clamping arrangements (15,15′), each clamping arrangement (15,15′) having first and second clamp members (17,19 and 17′,19′) respectively positionable on opposing sides of the respective upright posts (8,8′), said first and second clamp members respectively having facing sides with notches (33,33′) therein to receive the respective upright posts therebetween,
said first section (5) further including wall sections (39,39′) extending upwardly from the base member (25) respectively adjacent the clamping arrangements (15,15′), said wall sections (39,39′) respectively having a slot (45,45′) therethrough adjacent the respective clamping arrangement (15,15′) to respectively receive a threaded member (21,21′) through said slot (45,45′), each threaded member being further respectively received in the first and second clamp members (17,19 and 17′,19′) of each pair of clamping arrangements (15,15′) to draw the respective first and second clamp members of each pair toward one another with the respective upright post (8,8′) therebetween to fixedly secure said first section (5) of the mounting system (1) to said upright posts (8,8).

14. The mounting system of claim 13 wherein each of said slots (45,45′) in said wall sections (39,39′) is horizontally elongated.

15. The mounting system of claim 14 wherein at least one of the horizontally extending notches (27,27′) in the base member (25) is substantially T-shaped with a stem portion and a head portion.

16. The mounting system of claim 15 wherein both horizontally extending notches (27,27′) in the base member (25) are T-shaped with respective stem portions (29,29′) and head portions (31,31′).

17. The mounting system of claim 16 wherein the head portions (31,31′) are elongated and one of the elongated head portions (31′) is longer than the other.

18. The mounting system of claim 13 wherein said second section (7) is releasably securable to said first section (5) by a latching arrangement having mating male (53′) and female (70′) portions.

19. A mounting system (1) for releasably securing a rear-facing, entertainment module (3) to an automotive headrest (4), the headrest having two upright posts (8,8′) extending substantially vertically and parallel to each other, said mounting system including:
first and second sections (5,7), said first section (5) being securable to the two upright posts (8,8′) of said automotive headrest and said second section (7) being releasably securable to said first section (5) by a first latching arrangement and being releasably attachable to said entertainment module (3) by a second latching arrangement, said first and second latching arrangements of said second section (7) being mounted to each other for pivotal movement relative to each other about a substantially horizontal axis (H) when said second section (7) is secured by said first latching arrangement to said first section (5).

20. The mounting system of claim 19 wherein said first and second latching arrangements respectively have mating male and female portions (53′,70′ and 53,70), said male portions (53′ and 53) respectively including first and second latch members (57″,57′″ and 57,57′) respectively mounted for pivotal movement about first and second pivotal axes (59″,59′″ and 59,59′) between retracted and extended positions, said respective first and second axes 59″,59′″ and 59,59′) being substantially parallel to each other and each of said respective first and second latch members (57″,57′″ and 57,57′) being biased outwardly away from each other and away from the respective retracted positions and toward the respective extended positions,
said respective female portions (70′ and 70) of the respective latching arrangements having substantially parallel sidewalls (72″,72′″ and 72,72′) spaced for each other a first distance and said respective male portions (53′ and 53) having substantially parallel sidewalls (55″,55′″ and 55,55′) spaced from each other a second distance less than the respective first distance, said male portions (53′ and 53) being respectively receivable in said female portions (70′ and 70) with the respective sidewalls of the male and female portions substantially adjacent one another, said respective sidewalls (72″,72′″ and 72,72′) of the female portions including respective recessed areas (74″,74′″ and 74,74′) to respectively receive at least respective portions of the latch members (57″,57′″ and 57,57′) therein with the respective latch members in the extended positions, said latch members in the extended positions having respective segments (63″,63′″ and 63,63′) thereof extending outwardly beyond the respective sidewalls (55″,55′″ and 55,55′) of the respective male portions (53′ and 53) and into the respective recessed areas (74″,74′″ and 74,74′) of said female portions (70′ and 70) to latch the second section (7) to the first section (5) of the mounting system (1) in a predetermined, operation position relative thereto and to latch the entertainment module (3) to the second section (7) of said mounting system (1) in a predetermined, operating position relative thereto.

21. The mounting system of claim 20 wherein the respective segments (63″,63′″ and 63,63′) of the respective latch members (57″,57′″ and 57,57′) in the extended positions respectively extend outwardly of each other a third distance greater than the first distance the sidewalls (72″,72′″ and 72,72′) of said female portions (70′ and 70) are spaced from each other and wherein the respective segments (63″,63′″ and 63,63′) of the latch members (57″,57′″ and 57,57′) have respective ramp sections (65″,65′″ and 65,65′) inclined to the respective sidewalls (55,55′) of the male portions (53′ and 53) wherein the respective sidewalls (72″,72′″ and 72,72′) of the female portions (70′ and 70) as the respective male portions (53′ and 53) are received therein strike the inclined ramp sections and pivot the respective latch members away from the extended positions and toward the retracted positions to allow the respective sidewalls (72″,72′″ and 72,72′) of the respective female portions to pass by the respective latch members (57″, 57″″ and 57,57′).

22. The mounting system of claim 21 wherein the respective segments (63″,63′″ and 63,63′) of the latch members (57″,57′″ and 57,57′) have locking sections (67″,67′″ and 67,67′) adjacent the ramp sections and extending substantially perpendicular to the respective sidewalls (55″,55′″ and 55,55′) of the male portions (53′ and 53) with the respective latch members in said extended positions to be received in respective recessed areas (74″,74′″ and 74,74′) of the respective sidewalls (72″,72′″ and 72,72′) of the female portions (70′ and 70) to secure the male and female portions (53′,70′ and 53,70) in respective locked positions with the second section (7) in the predetermined, operating position thereof relative to the first section (5) of the mounting system (1) and the entertainment module (3) in the predetermined, operating position thereof relative to the second section (7) of the mounting system (1).

23. The mounting system of claim 22 further including respective release mechanisms to release the respective said male and female portions (53′,70′ and 53,70) from said respective locked position.

24. The mounting system of claim 23 wherein said release mechanisms include respective release sections (84″, 84′″ and 84,84′) on the latch members wherein the release sections can be manually engaged and moved toward each other to move the respective latch members (57″,57′″ and 57,57′) toward the respective retracted positions to release the locking sections of the latch members (57″,57′″ and 57,57′) of the respective male portions and the recessed areas (74″, 74′″ and 74,74′) of the female portions from engagement to allow the female portions to be moved along respective axes in a direction opposite to the first direction to respective remove the second section (7) from the first section (5) of the mounting system (1) and the entertainment module (3) from the second section (7) of the mounting system (1).
